(19) United States
(12) Patent Application Publication
(10) Pub. No.: US 2010/0073631 A1
(43) Pub. Date: Mar. 25, 2010

(54) DEVICE AND METHOD FOR REDUCING VISUAL ABERRATION

(76) Inventor: Debra A. Dretzke, New London, WI (US)

Correspondence Address: STEVEN H GREENFIELD, 4649 SEMINOLE TRAIL, GREEN BAY, WI, 54313, US

(21) Appl. No.: 12/549,242

(22) Filed: Aug. 27, 2009

Related U.S. Application Data
(60) Provisional application No. 61/192,950, filed on Sep. 22, 2008.

(51) Int. Cl. G02C 7/16; G02C 7/04

(52) U.S. Cl. 351/165; 351/160 R; 351/177

(57) ABSTRACT

A modified lens and a method of modifying a lens for alleviating visual aberrations such as glare, halos and starbursts from light sources are disclosed. The modified lens comprises an opaque patch containing a transparent area incorporated into a substantially transparent lens. The method of modifying the lens comprises determining the optimum shape, size and placement of the opaque patch and transparent area within the lens for each specific patient and incorporating the opaque patch into the lens.

### RELATED APPLICATIONS

This application claims priority from provisional application No. 61/192,950 filed on Sep. 22, 2008.

### FIELD OF THE INVENTION

The present invention relates to a device and methods to reduce certain visual aberration that involve the appearance of excessive lighting such as glare, halo, and starbursting.

### BACKGROUND OF THE INVENTION

Post refractive surgery patients often complain from visual aberrations that they describe as light that seems to overflow or seep outside its normal boundaries of light sources or sources of reflected light such as shiny objects, a phenomenon broadly defined as glare. Halos are another phenomena reported by some laser eye surgery patients, particularly at night. Halos are usually seen as huge globes of illuminated fog surrounding sources of light. Sometimes the globes seem to contain other globes, brighter and denser, nested two or more levels deep. Some laser eye surgery patients see rays or fine filaments coming off lights even during normal daytime lighting conditions. At night, these rays can become dramatically longer and denser, something referred to as ‘starbursting.’ Starbursts are highly variable between patients, differing in terms of their size and shape, length of rays, the density of rays, and transparency depending on whether the light source is visible through the starburst. From a simulation perspective, starbursts and halos exist on a continuum, with starbursts shading into halos as the rays become less distinct and diffuse into each other. These aberrations manifest themselves typically at night, but may at times occur during daylight.

Various methods and eye glass designs are used in prior art references to minimize these aberrations. U.S. Pat. No. 3,512,880 describes glare protective eyeglasses with lenses featuring light absorbent portions starting along vertical lines spaced laterally from visual axis centers in the lenses. U.S. Pat. No. 6,575,569 discloses a headlight glare reducing ophthalmic lens system as being incorporated into an eyeglass arrangement, or as an attachment to conventional eyeglasses, wherein the lens system is laterally adjustable to allow a user to select the amount of lens tint, or light transmisitivity, that is placed into his viewing path. U.S. Pat. No. 4,859,047 relates to Glare Reducing Night Driving Glasses having a wide, horizontal, wrap around, uniform filter lens (incident light rejection of 3 to 6 db). A narrow, horizontal, wrap around, linear gradient filter region which is integral with and located at the bottom edge of the uniform filter lenses (incident light rejection 3 to 6 db) are supported on a single frame. U.S. Pat. No. 4,828,380 provides anti-glare eyeglasses for drivers for shielding the glare of on-coming headlights and the glare of headlights of following vehicles reflected in rear view mirrors. The central vision area is bordered by a shaded area on the left side, the edge of the shaded area next to the central vision area is vertical and straight, the shaded area extends to the left at an angle corresponding to the apparent angle at which the on-coming headlights pass to the left of the driver, and additional shaded areas are provided to the left and right for screening the headlight glare of following vehicles reflected in rear view mirrors. U.S. Pat. No. 3,876,294 refers to a device constituted by a molded plate having a profile defining a pair of eyepieces joined to a nose piece, each eyepiece having a pattern of narrowly spaced pin holes therein adapted to project a clear image of the object viewed on the related eye of the wearer, the pin holes being treated to obviate corona effects. The spacing between holes in the pattern is such that when the plate is placed against the eyes, the eye is unable to resolve the hole pattern and the holes in each eyepiece appear to merge to form one large opening. U.S. Pat. No. 7,025,455 provides a multifocal lens that incorporates a substantially opaque ring. The lens design minimizes or eliminates ghosting of images. U.S. Pat. No. 7,455,408 teaches a light source is situated on a headgear device and placed to direct light toward the pupil of the eye at an intensity that causes the iris to constrict, resulting in a smaller pupil. This prevents the light scattering due to ophthalmic surgery or eye injury from entering the eye, thereby reducing or eliminating visual aberrations.

A problem with the prior art approaches is the tendency for interference with eyeglass wearer's field of vision during times when the wearer's visual abnormality is not acting up, such as during daylight.

### SUMMARY OF THE PRESENT INVENTION

In one aspect of the present invention, a modified lens for alleviating visual aberrations comprises: a substantially transparent lens having an upper section and a lower section; a substantially opaque patch disposed in a segment of the upper section of the lens; and a substantially transparent area contained within the opaque patch.

In another aspect of the present invention, a method for modifying a lens to reduce the effects of a patient's visual aberrations comprises: determining a proper shape and size of a transparent area for incorporating the transparent area into the transparent lens; determining a proper placement of the transparent area for incorporating the transparent area into the transparent lens; determining a proper shape and size of an opaque patch for incorporating the opaque patch into the transparent lens; incorporating the opaque patch of a proper size and shape into the transparent lens; and incorporating the transparent area into the transparent lens.

These and other features, aspects and advantages of the present invention will become better understood with reference to the following drawings, description and claims.

### BRIEF DESCRIPTION OF THE DRAWINGS

FIG. 1 is a front view of the modified lens according to an embodiment of the present invention;

FIG. 2 is also a front view of the modified lens according to an embodiment of the present invention; and

FIG. 3 is a front view of a component of the modified lens according to an embodiment of the present invention.

### DETAILED DESCRIPTION OF THE INVENTION

The present invention relates to a modified lens for alleviating visual aberrations comprising a substantially opaque patch disposed in an area of an upper section of the lens and a substantially transparent area contained within the patch. The patch may be attached to the lens or be permanently contained within the lens. The lens may be contained within a pair of prescription or non-prescription eyeglasses. If the eyeglasses contain a frame, the opaque patch would, in one embodiment of the present invention, be disposed near or in contact with the upper rim of the eyeglasses' frame. The scope of the invention includes most common type lenses used in eyeglasses including but not limited to tinted or translucent type lenses.

The present invention also relates to a method for determining the parameters of the lens that produce the optimum reduction in visual aberration for each specific sufferer.

To use the lens, a person prone to visual aberrations such as glare, halos or starbursts would, upon encountering a light source that produces such an aberration, bend his/her head down and view the light source through the transparent area in the opaque patch in the eyeglasses. The opaque patch would virtually remove the visual perception of the overflowing light typical to the aberrations of glare, halos and starburst. Once the light source that caused the aberration is out of view or if the person no longer desires or needs to view the light source, the person may lift his/her head and resume normal viewing through the eyeglasses. The modified lens would most typically be used at night, for example, during night time driving, but the device may also be used by persons who, though rare, suffer from visual aberrations during daylight.

The size and shape of the patch, the size and shape of the transparent area contained within the patch, the location of the patch on the lens, and the placement of the transparent area within the patch may vary depending on a variety of factors including but not limited to: the size of the lenses, the size of the person's pupils, and the nature of the aberration. While general design parameters may be established for these variables, a full determination may only be made by measurements, trials and feedback from the wearer of the lens. As such, a test protocol needs to be established that would result in the determination of the optimum parameters and settings with which the wearer is comfortable. It will be appreciated by persons skilled in the art that, though an optometrist or optical practitioner may use various measurements as a starting point, eyeglass prescriptions are ultimately determined by trying various lenses by the optometrist to identify the best lens configuration, then conduct additional fine tuning to correct for eye non-conformities such as astigmatism.

An embodiment of a method for configuring the lens for optimally alleviating a specific patient's visual aberrations comprises of the following general steps, which may not necessarily follow the outlined sequence:

1. Determining the proper size and location of the transparent area on the lens that corresponds to the affected eye or eyes. This may include:
a. Placing a pair of eyeglasses on the patient. The eyeglasses may be the patient's own prescription glasses or a non-prescription pair as appropriate.
b. With the patient bending his/her head down and looking straight ahead through the upper section of the lens but not over the rim, placing a non-permanent dot for marking a spot on the lens produced by the intersection of a horizontal line that connects the patient's pupil and the lens. This would identify the distance between the pupils and account for any differences in height between the pupils.
c. Measuring the size of the patient's un-dilated pupils in an appropriate light intensity and selecting a transparent area cut-out template that matches the size of the patient's un-dilated pupils. The transparent area cut-out template may be attached to the lens by means of a peel and stick film made of polypropylene; however other attachment means including an adhesive back are also within the context of the present invention.
d. Placing the transparent area cut-out template on the lens centered over the marking, then removing the non-permanent marking.
e. Lowering the lights to allow the practitioner and patient to check the alignment of the transparent area. If both eyes require a modified lens for reducing visual aberrations, covering one eye without moving the head, then the other eye to make sure that both eyes are focusing through their respective transparent areas.
f. Slightly moving each transparent area until it is lined up properly with the pupil and the patient is able to focus through them.

2. Determining the proper size of the opaque patch.

The opaque patch would be placed around the transparent area. The size of the patch may determine how well the aberrations are masked when the patient looks at the light through the transparent area. Here the optical practitioner may try various sizes to identify the size and shape of the patch that is optimum for the patient.

3. Testing the modified lens in the practitioner's office.

This may include simulating an artificial visual aberration by means of shining a light that would normally produce a halo or starburst and getting feedback from the patient. Adjustments to the placement and/or size of the transparent area and opaque patch are made as needed.

4. Field testing the modified lens by the patient for a period of time at the discretion of the patient. This may take several days to several weeks.

5. Manufacturing a modified lens for the patient by incorporating the appropriately scaled transparent area and opaque patch into a prescription or non-prescription lens.

The process of selecting the optimum sizes and determining the optimum spotting for the transparent area and the opaque patch may include introducing various preselected templates of varying sizes and into varying spots in the patient's field of vision using various instruments currently on the market. Feedback from the patient may be used to select the best cut out templates and to place them on the patient's lens or lenses.

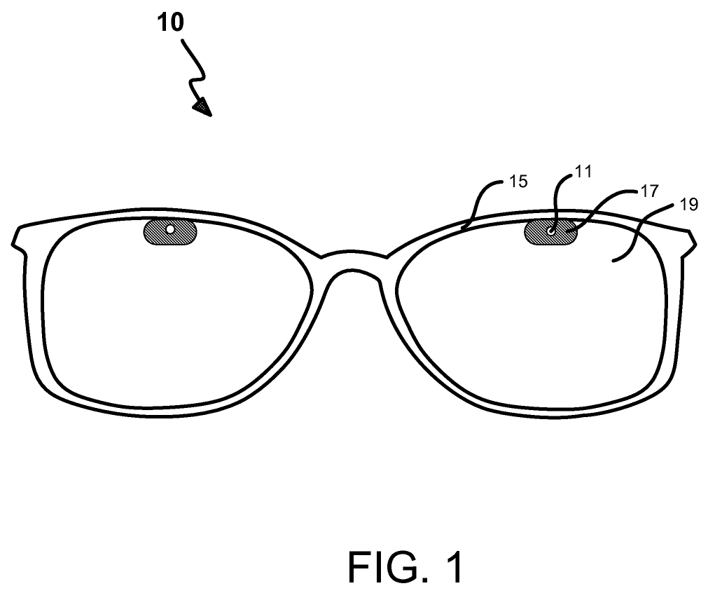

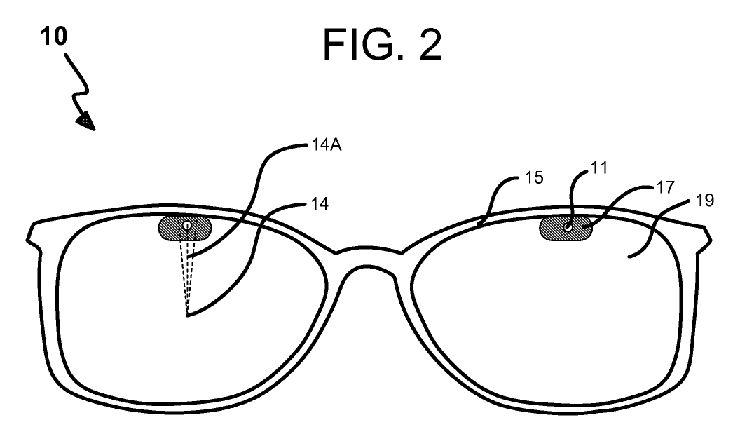

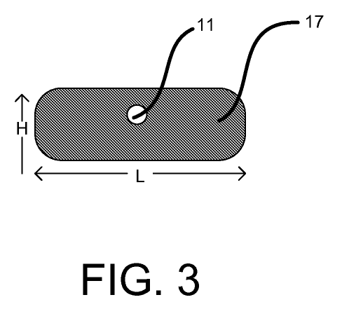

An embodiment of the present invention is described in FIGS. 1-3 showing the modified lens 10 comprising transparent lens 19 inside the frame 15. The transparent area 11 is shown inside the opaque patch 17. FIG. 2 shows a point at the center of the lens 14 that maybe used for determining the best location for the transparent by drawing vertical line 14A and lines on each side of the vertical line indicating limits to possible horizontal displacements for the transparent area. The transparent area will ideally be located between the two outer lines or a distance of about 2 mm on each side of the center line. The preferred shape for the patch is rectangular with rounded corners having a specific length, L and a height H as shown in FIG. 3.

While the optimum size of the transparent area is patient specific, an area having a substantially circular shape with a diameter in the range of about 2 mm to about 4 mm that approximately matches the size of an un-dilated pupil has been found to provide the best performance. However, other shapes including but not limited to oval, rectangular, square, triangular, and oblong also fall within the scope of the present invention. Likewise the optimum size and shape of the opaque patch is patient specific. However, the empirical optimum shape of the opaque patch of the present invention is rectangular with rounded corners having a specific length, L and a height H as shown in FIG. 3, where the length ranges between about 8 mm to about 14 mm and a height ranges between about 6 mm to about 10 mm.

To remove the halo and starburst effects, a person would bend his/her head and look at the light creating the aberration through the transparent area located near the upper section of the lens close to the upper rim. The opaque patch would mask the aberration. After the source of the light is out of view, the person may return to viewing with his/her normal posture. The advantage of placing the transparent area and opaque patch near the upper section of the lens and close to the upper rim is the minimization of any blind spot that might interfere with the person's normal viewing. The present invention can also accommodate a photochromic lens such as Transition® that turns dark in sunlight. The present invention also applies to contact lenses, but the size of the transparent area and opaque patch would be smaller in approximate proportion to the relative sizes of the contact lens and eyeglass lens. It also may be used with lenses made from a wide range of materials of construction including glass and plastic. The opaque patch may comprise of a range of colors from grey to black, but other opaque colors also fall within the scope of the present invention. The transparent area may comprise an aperture in the transparent lens.

The opaque patch may be incorporated into the lens by various methods known in the art. These include the use of dyes, the use of oxides, and methods disclosed in U.S. Pat. Nos. 5,662,706, 7,025,455, and 6,224,492.

I claim:

1. A modified lens for alleviating visual aberrations comprising:
a substantially transparent lens having an upper section and a lower section;
a substantially opaque patch disposed in a segment of the upper section of the lens; and
a substantially transparent area contained within said opaque patch.

2. The modified lens of claim 1, wherein the lens is an eyeglass lens.

3. The modified lens of claim 1, wherein the lens is a contact lens.

4. The modified lens of claim 1, wherein the transparent area is attached to the transparent lens.

5. The modified lens of claim 1, wherein the transparent area is incorporated into the transparent lens.

6. The modified lens of claim 1, wherein the transparent area comprises an aperture in the transparent lens.

7. The modified lens of claim 1, wherein the opaque patch is attached to the transparent lens.

8. The modified lens of claim 1, wherein the opaque patch is incorporated into the transparent lens.

9. The modified lens of claim 1, wherein the transparent area is disposed around a vertical line drawn from a center point of the substantially transparent lens to the upper segment of said lens.

10. The modified lens of claim 1, wherein the opaque patch is substantially rectangular having a length in a range of between about 8 mm to about 14 mm and a height of between about 6 mm to about 10 mm.

11. The modified lens of claim 1, wherein the transparent area is substantially circular having a diameter in a range between about 2 mm to about 4 mm.

12. A method for modifying a transparent lens to reduce the effects of a patient's visual aberrations comprising:
determining a proper shape and size of a transparent area for incorporating said transparent area into the transparent lens;
determining a proper placement of the transparent area for incorporating said transparent area into the transparent lens;
determining a proper shape and size of an opaque patch for incorporating said opaque patch into the transparent lens;
incorporating said opaque patch of the proper size and shape into the transparent lens; and
incorporating said transparent area into the transparent lens.

13. The method of claim 12, wherein said transparent area being disposed within the opaque patch.

14. The method of claim 12, wherein the transparent area and the opaque patch are disposed in an upper section of the transparent lens.

15. The method of claim 14, wherein determining a proper shape, size and placement of the transparent area and opaque patch comprises:
measuring a size of the patient's un-dilated pupils in an appropriate light intensity;
with the patient looking straight ahead through the upper section of the lens, marking a dot on a spot on the lens produced by an intersection of a horizontal line that connects the patient's pupil and the transparent lens;
with the patient looking ahead through the upper section of the lens into a halo triggering light, bringing into the patient's view a series of opaque patches each containing a transparent area, said each transparent area being positioned around the dot, said opaque patches varying in size and shape, said transparent areas contained in the opaque patches also varying in size and shape;
based on feedback from the patient, selecting the combination of opaque patch and transparent area the patient feels most comfortable with;
placing a transparent area cut-out template that matches said combination on the transparent lens; and
testing and evaluating the combination.

16. The method of claim 15, wherein bringing a series of opaque patches each containing a transparent area into the patient's view comprises superimposing appropriate images onto the patient's field of vision with the patient wearing the transparent lens.

17. The method of claim 15, wherein bringing a series of opaque patches each containing a transparent area into the patient's view comprises placing cut out templates on the lens.

18. The method of claim 15 further comprising making adjustments to the placement of the opaque patch and the transparent area based on feedback from the patient.

19. The method of claim 18 further comprising making adjustments to the sizes and shapes of the opaque patch and the transparent area based on feedback from the patient.
